(19) United States
(12) Patent Application Publication
(10) Pub. No.: US 2024/0109410 A1
(43) Pub. Date: Apr. 4, 2024

(54) SYSTEMS FOR A COUPLING DEVICE

(71) Applicant: Dana Heavy Vehicle Systems Group, LLC, Maumee, OH (US)

(72) Inventors: Nicholas W. LAFORCE, Whitehouse, OH (US); Douglas B. KIEFER, Maumee, OH (US); Dennis T. MAHONEY, Sylvania, OH (US)

(21) Appl. No.: 18/474,525

(22) Filed: Sep. 26, 2023

Related U.S. Application Data
(60) Provisional application No. 63/378,159, filed on Oct. 3, 2022.

(51) Int. Cl. B60K 17/04; F16H 57/025

(52) U.S. Cl. CPC B60K 17/04; F16H 57/025; F16H 2057/02043

(57) ABSTRACT

Systems are provided for a coupling element. In one example, a system includes a coupling element comprising an elongated body, a first lobe coupled to a first end of the elongated body, and a second lobe coupled to a second end of the elongated body opposite the first end, wherein the elongated body comprises a top surface separated from the first lobe via a first recess and from the second lobe via a second recess.

### CROSS REFERENCE TO RELATED APPLICATION

The present application claims priority to U.S. Provisional Application No. 63/378,159, entitled “SYSTEMS FOR A COUPLING DEVICE”, and filed on Oct. 3, 2022. The entire contents of the above-listed application are hereby incorporated by reference for all purposes.

### TECHNICAL FIELD

The present description relates generally to a coupling device of a vehicle.

### BACKGROUND AND SUMMARY

Vehicles may experience harsh road conditions. Vibrations and other symptoms as a result of the road conditions may increase wear on vehicle components. Heavier vehicle components may be prone to reduced longevity of coupling and/or other mounting elements due to road conditions. In some instances, the coupling elements of these components may change over time in response to repeated exposure to certain road conditions, which may result changes in vehicle performance.

In one example, the issues described above may be at least partially solved by a system including a coupling element comprising an elongated body, a first lobe coupled to a first end of the elongated body, and a second lobe coupled to a second end of the elongated body opposite the first end, wherein the elongated body comprises a top surface separated from the first lobe via a first recess and from the second lobe via a second recess. By doing this, the pressure distributed by fasteners mounting the coupling element to a flange of a component is uniform, resulting in enhanced pressure across the elongated body. This may reduce a likelihood of leaks and/or loosening.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle powertrain, according to an embodiment of the present disclosure;

FIG. 2 is an embodiment of a coupling element coupled to a carrier flange, according to an embodiment of the present disclosure;

FIG. 3A is an embodiment of a top-down view of the coupling element, according to an embodiment of the present disclosure;

FIG. 3B is an embodiment of a side-on view of the coupling element, according to an embodiment of the present disclosure;

FIG. 3C is an embodiment of a perspective view of the coupling element, according to an embodiment of the present disclosure;

FIG. 4A is a pressure map of the carrier flange according to embodiments of the present disclosure;

FIGS. 4B and 4C are a pressure map of the carrier flange according to prior art examples;

FIG. 5A is a pressure map of the carrier flange with a gearbox according to embodiments of the present disclosure;

FIGS. 5B-5C are a pressure map of the carrier flange with a gearbox according to prior art examples;

FIG. 6A is a pressure map of the coupling element according to an embodiment of the present disclosure; and

FIG. 6B is a pressure map of the coupling element according to the prior art.

### DETAILED DESCRIPTION

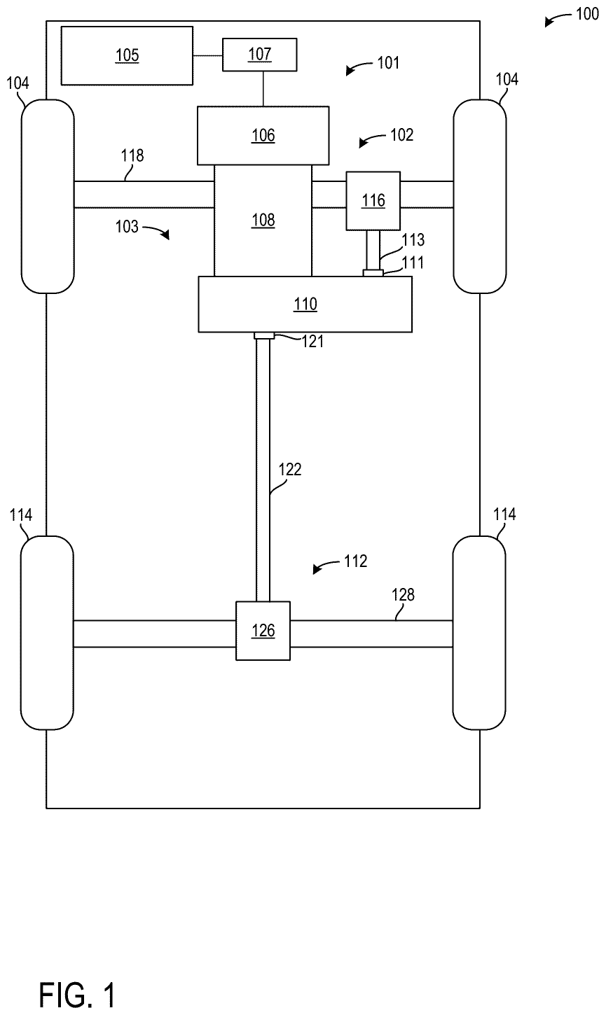

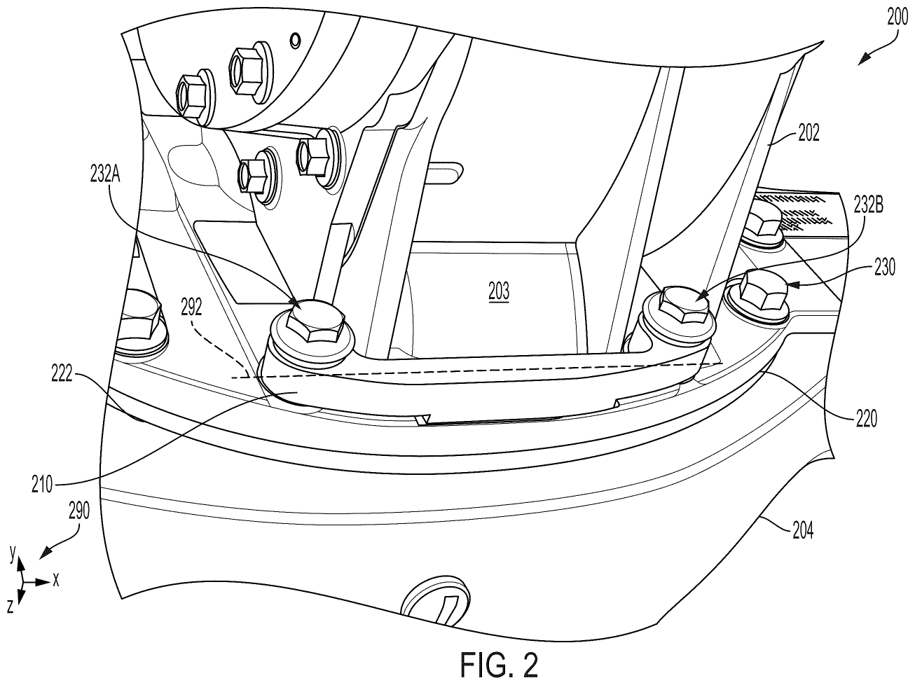

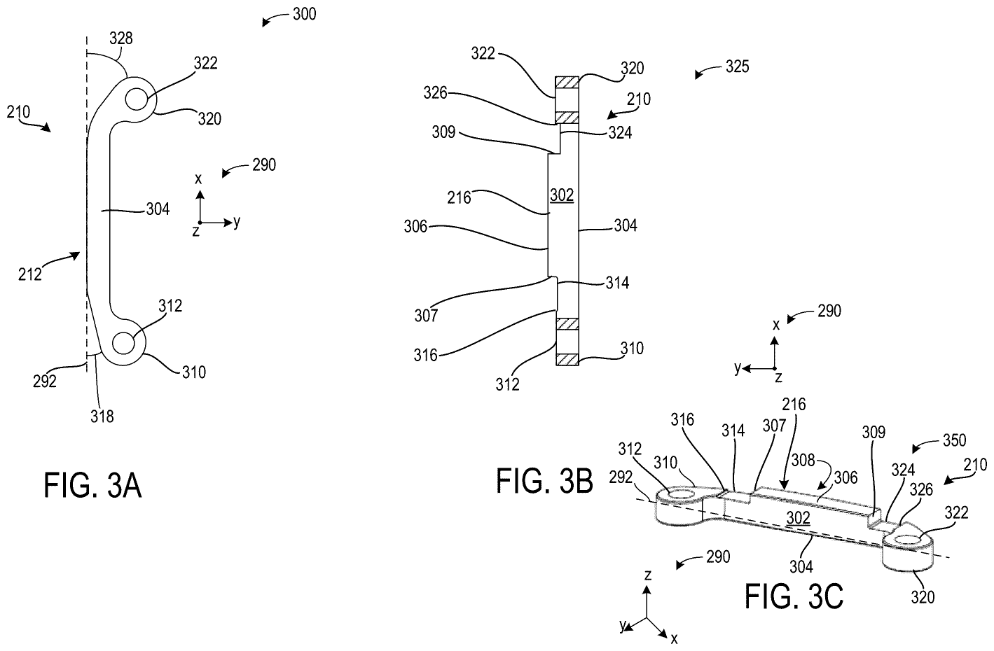

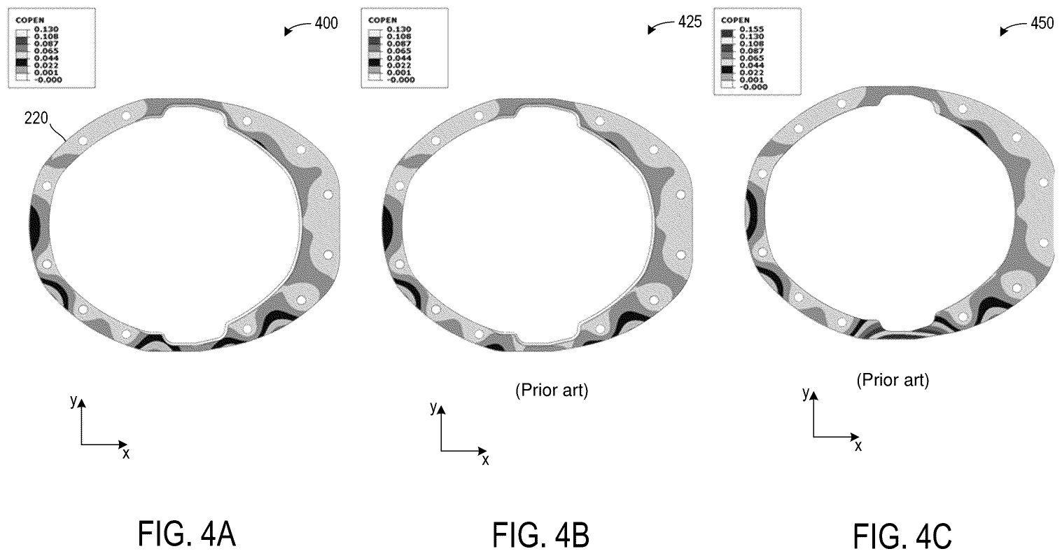

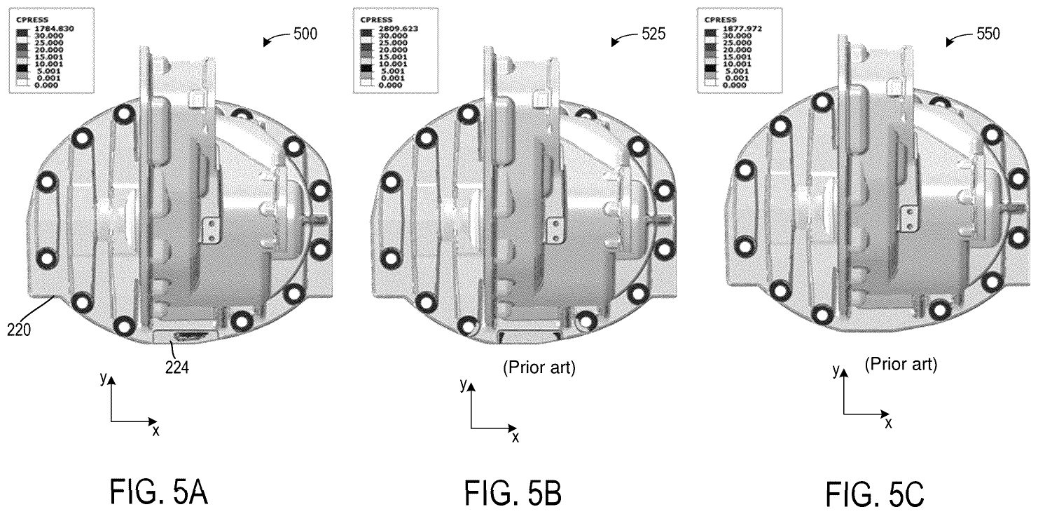

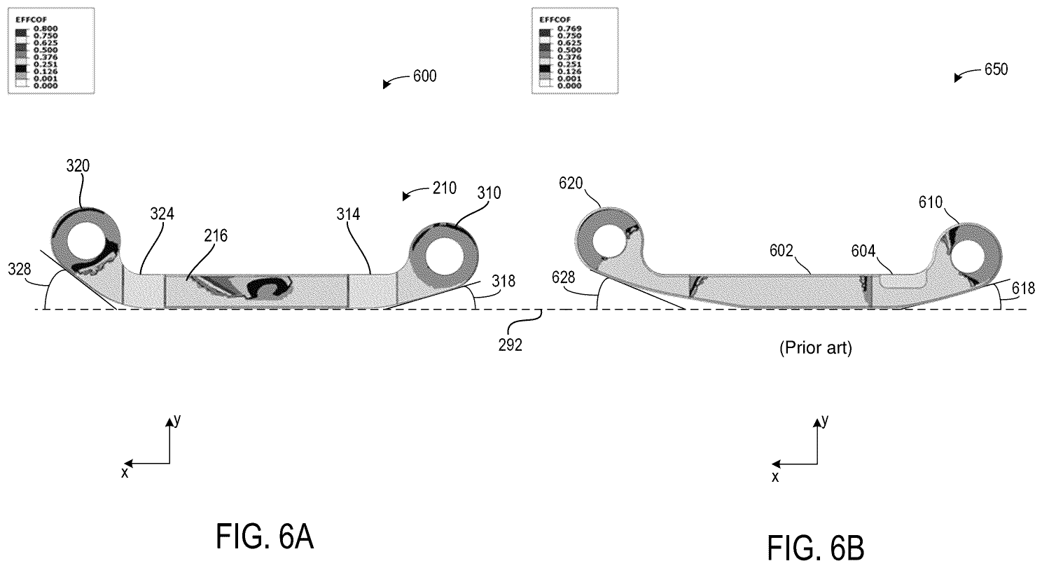

The following description relates to a coupling element. In one example, the coupling element couples to a flange of a gearbox of a vehicle, such as an example vehicle shown in FIG. 1. FIG. 2 shows an embodiment of a coupling element coupled to a carrier flange. FIG. 3A is an embodiment of a top-down view of the coupling element. FIG. 3B is an embodiment of a side-on view of the coupling element. FIG. 3C is an embodiment of a perspective view of the coupling element. FIG. 4A is a pressure map of the carrier flange according to embodiments of the present disclosure. FIGS. 4B and 4C are a pressure map of the carrier flange according to prior art examples. FIG. 5A is a pressure map of the carrier flange with a gearbox according to embodiments of the present disclosure. FIGS. 5B-5C are a pressure map of the carrier flange with a gearbox according to prior art examples. FIG. 6A is a pressure map of the coupling element according to an embodiment of the present disclosure. FIG. 6B is a pressure map of the coupling element according to the prior art.

FIGS. 1-6B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-4A, 5A, and 6A are shown approximately to scale, however, other dimensions may be used if desired.

Turning now to FIG. 1, a vehicle 100 is shown comprising a powertrain 101 and a drivetrain 103. The powertrain comprises a prime mover 106 and a transmission 108. The prime mover 106 may be an internal combustion engine or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting.

The prime mover 106 may be powered via energy from an energy storage device 105. In one example, the energy storage device 105 is a battery configured to store electrical energy. An inverter 107 may be arranged between the energy storage device 105 and the prime mover 106 and configured to adjust direct current (DC) to alternating current (AC).

The vehicle 100 may be a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications. In one example, the vehicle 100 is an electric vehicle.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

Turning now to FIG. 2, it shows an embodiment 200 of a coupling element 210 coupled to a flange 220. In one example, the flange 220 is a gearbox cover. The flange 220 may be a carrier flange 222 of a gearbox 202 of the transmission 108. The flange 220 may be coupled to a housing 204 via a plurality of fasteners 230. The plurality of fasteners 230 may be bolts or similar devices comprising a first length. The plurality of fasteners 230 may be in direct, face-sharing contact with the flange 220, wherein a threaded portion of the plurality of fasteners 230 may engage with complementary features of the housing 204. In one example, the gearbox 202 is mounted to an axle.

An axis system 290 comprises three axes, namely an x-axis parallel to a longitudinal direction, a y-axis parallel to a lateral direction, and a z-axis normal to the x- and y-axes. A longitudinal axis 292 of the coupling element 210 is parallel to the x-axis.

A pair of fasteners, including a first fastener 232A and a second fastener 232B, may physically couple the coupling element 210 to the flange 220. The first fastener 232A and the second fastener 232B may be longer than each of the plurality of fasteners 230. In one example, a difference in size of the first fastener 232A and the second fastener 232B may be proportional to a thickness of the coupling element 210 measured along the z-axis. The first fastener 232A and the second fastener 232B may be in face-sharing contact with the coupling element 210 and extend through through-holes thereof. The first fastener 232A and the second fastener 232B may extend through the flange 220 and the carrier flange 222, wherein threaded portions thereof may engage with complementary features of the housing 204.

The coupling element 210 may be located adjacent to only a first side 203 of the gearbox 202. In one example, the first side 203 is a first lateral side of the gearbox 202, further comprising a second lateral side opposite the first lateral side. The gearbox 202 may further include a first longitudinal side and a second longitudinal side extending between the first and second lateral sides. In this way, the coupling element 210 may be furthest from the second lateral side and closest to the first lateral side.

When the coupling element 210 is physically coupled to the flange 220, a first side 212 of the coupling element 210 faces a first direction away from the flange 220. A second side 214 of the coupling element 210, opposite the first side 212, may be in face a second direction, opposite the first direction, toward the flange 220.

The second side 214 may include a protrusion 216 that extends into a recess 224 of the flange 220. In one example, the recess 224 may be located only in the flange 220 and does not extend into or contact the carrier flange 222. A shape of the protrusion 216 may be complementary to a shape of the recess 224. In one example, surfaces of the protrusion 216 may be in face-sharing contact with interior surfaces of the recess 224 of the flange 220.

Turning now to FIGS. 3A, 3B, and 3C, they show a top-down view 300, a cross-sectional view 325, and a perspective view 350 of the coupling element 210, respectively. FIGS. 3A-3C are described in tandem herein.

The coupling element 210 comprises an elongate portion 302 on the first side 212. The elongate portion 302 extends in a direction parallel to the longitudinal axis 292. The elongate portion 302 may include a base 304 and a top surface 306. When the coupling element 210 is coupled to a flange, such as flange 220 of FIG. 2, the base 304 may be pressed against the flange and the top surface 306 may be exposed.

A length of base 304 may be greater than a length of the top surface 306. In one example, the top surface 306 defines a portion of the protrusion 216. The base 304 and the top surface 306 may be parallel to one another and a distance therebetween may define a thickness of the coupling element 210. In one example, the thickness of the coupling element 210 is a maximum thickness of the coupling element 210, wherein the thickness of the coupling element 210 may be reduced at other sections.

The coupling element 210 may further include a first lobe 310 and a second lobe 320. The first lobe 310 may be positioned at a first end of the elongate portion 302. The second lobe 320 may be positioned at a second end of the elongate portion 302, opposite the first end. Each of the first lobe 310 and the second lobe 320 may comprise a circular shape, wherein a transition from the elongate portion 302 to each of the first lobe 310 and the second lobe 320 may be curved. In one example, a magnitude of the curvature of the transition from the elongate portion 302 to the first lobe 310 may be different than a magnitude of the curvature of the transition from the elongate portion 302 to the second lobe 320.

The first lobe 310 may include a first through-hole 312. The second lobe 320 may include a second through-hole 322. The first fastener (e.g., the first fastener 232A of FIG. 2) may extend through the first through-hole 312 and the second fastener (e.g., the second fastener 232B of FIG. 2) may extend through the second through-hole 322. A direction in which the first fastener extends through the first through-hole 312 may be parallel to a direction in which the second fastener extends through the second through-hole 322. The first through-hole 312 and the second through-hole 322 extend through the base 304.

The elongate portion 302 may further include a first recess 314 and a second recess 324. The first recess 314 may be arranged between the top surface 306 and the first lobe 310. The second recess 324 may be arranged between the top surface 306 and the second lobe 320. In one example, one or more of the first recess 314 and the second recess 324 may follow a curvature of the coupling element 210 from the elongated body to the first lobe 310 and the second lobe 320, respectively.

As shown in FIG. 3B, a height and a length of the first recess 314 and the second recess 324 may be different. For example, a height of the first recess 314 may be less than a height of the second recess 324, wherein the heights are measured along the y-axis. Thus, a corresponding thickness of the coupling element 210 may be greater at the first recess 314 relative to the second recess 324. A first top surface lip 307 facing the first recess 314 may be smaller than a second top surface lip 309 facing the second recess 324. Additionally, a first first lobe lip 316 facing the first recess 314 may be smaller than a second second surface lip 326 facing the second recess 324. Additionally or alternatively, a length of the first recess 314 may be greater than a length of the second recess 324, wherein the lengths are measured along the x-axis. In one example, the first top surface lip 307, the second top surface lip 309, and the top surface 306 may shape a portion of the protrusion 216. The protrusion 216 may be further shaped by the elongate portion 302. In one example, the elongate portion 302 is a first elongate portion, wherein the coupling element 210 further comprises a second elongate portion 308, opposite the first elongate portion. The first elongate portion 302 and the second elongate portion 308 may shape a portion of the protrusion 216. In one example, the protrusion 216 may include a rectangular prism shape.

The first lobe 310 and the second lobe 320 may be further differentiated from one another relative to an angle at which each extends from the longitudinal axis 292. The first lobe 310 may extend at a first angle 318 from the longitudinal axis 292 and the second lobe 320 may extend at a second angle 328 from the longitudinal axis 292. In one example, the first angle 318 may be less than the second angle 328. As such, the first lobe 310 may be closer to the longitudinal axis 292 than the second lobe 320. The first angle 318 may be between 10 and 20 degrees. In some examples, additionally or alternatively, the first angle 318 is between 13 and 17 degrees. In one example, the first angle is 14.7 degrees. The second angle 328 may be between 30 to 40 degrees. In some examples, additionally or alternatively, the second angle 328 may be between 35 to 40 degrees. In one example, the second angle 328 is exactly 37.3 degrees.

In one example, the coupling element 210 comprises a linear section comprising the protrusion 216. The linear section further comprises a first extreme end at which the first lobe 310 is arranged. The first lobe 310 deviates from the longitudinal axis 292 of the linear section by the first angle 318. The linear section further comprises a second extreme end, opposite the first extreme end, at which the second lobe 320 is arranged. The second lobe 320 deviates from the longitudinal axis 292 by the second angle 328. The second angle 328 is different than the first angle 318.

The first first lobe lip 316 may interface between the first lobe 310 and the linear section. In one example, the linear section comprises the first recess 314 between the first first lobe lip 316 and the protrusion 216. The first lobe 310 may include a ramp profile, wherein a thickness of the coupling element 210 decreases from the first first lobe lip 316 to an extreme end of the first lobe 310 furthest from the first extreme end of the linear section.

The second second lobe lip 326 may interface between the second lobe 320 and the linear section. In one example, the linear section comprises the second recess 324 between the second second lobe lip 326 and the protrusion 216. The second lobe 320 may include a ramp profile, wherein a thickness of the coupling element 210 decreases from the second second lobe lip 326 to an extreme end of the second lobe 320 furthest from the second extreme end of the linear section.

In one example, the ramp profile of the second lobe 320 may be identical to the ramp profile of the first lobe 310. Additionally or alternatively, the ramp profile of the second lobe 320 may differ from the ramp profile of the first lobe 310. In one example, the ramp profile of the second lobe 320 may be steeper than the ramp profile of the first lobe 310.

In one example, only the portion of the linear section corresponding to the protrusion 216 comprises a form of symmetry. The entirety of the linear section, which includes the protrusion 216, the first recess 314, and the second recess 324 may be asymmetric. Additionally, an entirety of the coupling element 210 may be asymmetric. The coupling element 210 may be manufactured as a single piece. The coupling element 210 may include one or more of aluminum, steel, stainless steel, carbon fiber, magnesium, titanium, alloys thereof, and other materials.

Turning now to FIGS. 4A, 4B, and 4C, they show an embodiment 400 of the flange 220 of the present disclosure, a first prior art example 425, and a second prior art example 450, respectively. The figures illustrate a pressure distribution across the respective flanges with a corresponding coupling element. The embodiment 400 illustrates a pressure map of the flange 220 when the coupling element 210 is coupled thereto. The prior art examples 425 and 450 illustrate a pressure map when a prior art coupling element, such as the coupling element of FIG. 6B is coupled thereto.

Turning now to FIGS. 5A, 5B, and 5C, they show an embodiment 500 of the flange 220 and the gearbox 202 of the present disclosure, an embodiment 525 of a first prior art example, and an embodiment 550 of a second prior art example, respectively. The figures illustrate a pressure distribution across the respective flanges with a corresponding coupling element. The embodiment 500 illustrates a pressure map of the flange 220 when the coupling element 210 is coupled thereto. The prior art examples 525 and 550 illustrate a pressure map when a prior art coupling element, such as the coupling element of FIG. 6B is coupled thereto. As shown, the coupling element applies a pressure to the recess 224 via its protrusion that is not present in the prior art examples. By doing this, a stress load is more even distributed across the flange 220, which may increase a longevity and a durability of the system.

Turning now to FIGS. 6A and 6B, they show an embodiment 600 of the coupling element 210 of the present disclosure and a prior art example 650 of a coupling element 602. The coupling element 602 may include only a single recess 604 adjacent to a first lobe 610. The single recess 604 may extend along only a portion of a width of the coupling element. Additionally, the first lobe 610 may extend from the longitudinal axis 292 at a first angle 618 equal to 15.5 degrees. The coupling element 602 may further include a second lobe 620 that may extend from the longitudinal axis 292 at a second angle 628 equal to 22.5 degrees.

The differences between the coupling element 210 of the present disclosure compared to the coupling element 602 of the prior art results in flange greater center clamp distribution along a center of the coupling element 210 at its protrusion 216 and into the recess 224 of the flange 220. Additionally, the clamp distribution extends to the first lobe 310 and the second lobe 320 at a greater magnitude relative to the coupling element 602 of the prior art. In one example, the flange responds to the coupling element 210 as if a third fastener were to extend through the protrusion 216 of the coupling element 210, thereby increasing a seal of a leak zone. In this way, the protrusion 216 may function as a third fastener, whereby a manufacturing cost and time associated with a third fastener is eliminated. A pressure distribution between the pair of fasteners extending through the coupling element 210 may be more uniform relative to the prior art coupling element 602, which may result in reduced fatigue and decreased likelihood of loosening.

The disclosure provides support for a system including a coupling element comprising an elongated body, a first lobe coupled to a first end of the elongated body, and a second lobe coupled to a second end of the elongated body opposite the first end, wherein the elongated body comprises a top surface separated from the first lobe via a first recess and from the second lobe via a second recess. A first example of the system further includes where the first recess is different than the second recess. A second example of the system, optionally including the first example, further includes where the elongated body extends in a direction parallel to a longitudinal axis, and wherein the first lobe extends at a first angle from the elongated body and the second lobe extends at a second angle from the elongated body. A third example of the system, optionally including one or more of the previous examples, further includes where the second angle is greater than the first angle. A fourth example of the system, optionally including one or more of the previous examples, further includes where the second angle is greater than 30 degrees. A fifth example of the system, optionally including one or more of the previous examples, further includes where the second angle is between 35 to 40 degrees.

The system provides additional support for a coupling element for a gearbox of a vehicle including an elongated body extending in a direction parallel to a longitudinal axis, a first lobe extending from a first end of the elongated body at a first angle relative to the longitudinal axis, and a second lobe extending from a second end of the elongated body at a second angle relative to the longitudinal axis, wherein the second angle is greater than the first angle. A first example of the coupling element further includes where the elongated body comprises a base in face sharing contact with a flange of the gearbox. A second example of the coupling element, optionally including the first example, further includes where the elongated body comprises a top surface facing a direction away from the flange and parallel to the base. A third example of the coupling element, optionally including one or more of the previous examples, further includes where the elongated body comprises a first recess arranged between the top surface and the first lobe and a second recess arranged between the top surface and the second lobe. A fourth example of the coupling element, optionally including one or more of the previous examples, further includes where the second recess comprises a height greater than a height of the first recess. A fifth example of the coupling element, optionally including one or more of the previous examples, further includes where the second recess extends along a curvature of the second lobe. A sixth example of the coupling element, optionally including one or more of the previous examples, further includes where a protrusion is arranged on the elongated body, the protrusion shaped to insert into a recess of a flange of the gearbox. A seventh example of the coupling element, optionally including one or more of the previous examples, further includes where the protrusion is sandwiched between a first recess and a second recess. An eighth example of the coupling element, optionally including one or more of the previous examples, further includes where the first lobe and the second lobe comprise ramped surfaces that ramp upward toward the elongated body.

The disclosure provides further support for a system including a gearbox comprising a cover physically coupled to a housing via a first plurality of fasteners and a coupling element physically coupled to the cover via a second plurality of fasteners, wherein the coupling element comprising an elongate body with a first lobe arranged at a first extreme end and a second lobe arranged at a second extreme end opposite the first extreme end, wherein the elongate body comprises a protrusion that inserts into a recess of the cover. A first example of the system further includes where the coupling element further comprises a first recess between the protrusion and the first lobe and a second recess between the protrusion and the second lobe. A second example of the system, optionally including the first example, further includes where the first lobe deviates from a longitudinal axis of the coupling element by a first angle and the second lobe deviates from the longitudinal axis of the coupling element by a second angle, the second angle different than the first angle. A third example of the system, optionally including one or more of the previous examples, further includes where the coupling element is asymmetric. A fourth example of the system, optionally including one or more of the previous examples, further includes where the protrusion presses against interior surfaces of the recess.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a coupling element comprising an elongated body, a first lobe coupled to a first end of the elongated body, and a second lobe coupled to a second end of the elongated body opposite the first end, wherein the elongated body comprises a top surface separated from the first lobe via a first recess and from the second lobe via a second recess.

2. The system of claim 1, wherein the first recess is different than the second recess.

3. The system of claim 1, wherein the elongated body extends in a direction parallel to a longitudinal axis, and wherein the first lobe extends at a first angle from the elongated body and the second lobe extends at a second angle from the elongated body.

4. The system of claim 3, wherein the second angle is greater than the first angle.

5. The system of claim 3, wherein the second angle is greater than 30 degrees.

6. The system of claim 3, wherein the second angle is between 35 to 40 degrees.

7. A coupling element for a gearbox of a vehicle, comprising:
an elongated body extending in a direction parallel to a longitudinal axis;
a first lobe extending from a first end of the elongated body at a first angle relative to the longitudinal axis; and
a second lobe extending from a second end of the elongated body at a second angle relative to the longitudinal axis, wherein the second angle is greater than the first angle.

8. The coupling element of claim 7, wherein the elongated body comprises a base in face sharing contact with a flange of the gearbox.

9. The coupling element of claim 8, wherein the elongated body comprises a top surface facing a direction away from the flange and parallel to the base.

10. The coupling element of claim 9, wherein the elongated body comprises a first recess arranged between the top surface and the first lobe and a second recess arranged between the top surface and the second lobe.

11. The coupling element of claim 10, wherein the second recess comprises a height greater than a height of the first recess.

12. The coupling element of claim 10, wherein the second recess extends along a curvature of the second lobe.

13. The coupling element of claim 7, wherein a protrusion is arranged on the elongated body, the protrusion shaped to insert into a recess of a flange of the gearbox.

14. The coupling element of claim 13, wherein the protrusion is sandwiched between a first recess and a second recess.

15. The coupling element of claim 7, wherein the first lobe and the second lobe comprise ramped surfaces that ramp upward toward the elongated body.

16. A system, comprising:
a gearbox comprising a cover physically coupled to a housing via a first plurality of fasteners; and
a coupling element physically coupled to the cover via a second plurality of fasteners, wherein
the coupling element comprising an elongate body with a first lobe arranged at a first extreme end and a second lobe arranged at a second extreme end opposite the first extreme end, wherein the elongate body comprises a protrusion that inserts into a recess of the cover.

17. The system of claim 16, wherein the coupling element further comprises a first recess between the protrusion and the first lobe and a second recess between the protrusion and the second lobe.

18. The system of claim 16, wherein the first lobe deviates from a longitudinal axis of the coupling element by a first angle and the second lobe deviates from the longitudinal axis of the coupling element by a second angle, the second angle different than the first angle.

19. The system of claim 16, wherein the coupling element is asymmetric.

20. The system of claim 16, wherein the protrusion presses against interior surfaces of the recess.
